(19) United States
(12) Patent Application Publication
(10) Pub. No.: US 2011/0170912 A1
(43) Pub. Date: Jul. 14, 2011

(54) TONER CARTRIDGE AND ITS RECYCLING METHOD (as amended)

(75) Inventors: Toshihide Taniguchi, Hachioji-shi (JP); Kunio Toda, Hachioji-shi (JP); Ikuo Ichino, Hachioji-shi (JP); Shigehisa Nakayama, Shinshiro-shi (JP); Kenichi Wada, Hachioji-shi (JP); Shouji Imaizumi, Toyokawa-shi (JP); Kenzo Toya, Okazaki-shi (JP); Hiroshi Ozawa, Toyokawa-shi (JP)

(73) Assignee: Konica Minolta Business Technologies, Inc, tokyo (JP)

(21) Appl. No.: 13/119,683

(22) PCT Filed: Sep. 4, 2009
(86) PCT No.: PCT/JP2009/065506

§ 371 Date: Mar. 17, 2011

(30) Foreign Application Priority Data
Sep. 19, 2008 (JP) 2008-241070

(51) Int. Cl. G03G 15/08

(52) U.S. Cl. 399/262

(57) ABSTRACT

The present invention provides a toner cartridge and its recycling method in which a clearance due to stack of the housing and the lid can reliably be sealed so that toner leakage can be prevented. A toner cartridge which is set in an image forming apparatus to feed toner to the image forming apparatus includes a housing having a toner containing portion for containing toner therein, and a lid for covering the toner containing portion of the housing. A stack portion where the housing and the lid are stacked on each other is sealed by a sealing member having first and second adhesive materials provided on both-side surfaces of a base material with the first adhesive material stuck on an outer peripheral surface of the stack portion and with a release paper stuck on the second adhesive material.

### REFERENCE TO RELATED APPLICATIONS

This application is a national stage application under 35 USC 371 of International Application No. PCT/JP2009/065506, filed Sep. 4, 2009, which claims the priority of Japanese Application No. 2008-241070, filed Sep. 19, 2008, the contents of which prior applications are incorporated herein by reference.

### FIELD OF THE INVENTION

The present invention relates to a toner cartridge for image forming apparatuses such as full-color copiers and printers, specifically, relates to a toner cartridge prevented from toner leakage in recycling process by a simple method.

### BACKGROUND OF THE INVENTION

In toner cartridges used for conventional image forming apparatuses, a clearance between a housing and a lid, if present, would cause toner blowoff or the like that stains vicinities of a developing section, which is undesirable for image formation. Therefore, the housing and the lid are sealed by welding or the like so that no clearance is present.

However, with the above-described technique, since opening the lid involves formation of recesses and protrusions in bonding portions, the welding work cannot be performed again, making it impossible to do recycling.

Further, when the toner cartridge is sealed with tape without doing the welding work, peeling the tape in recycling causes an adhesive portion to be left on the housing side. As a result, recesses and protrusions are formed on the surface. Thus, even if an attempt to seal the toner cartridge with tape is conducted once again, the clearance of the surface could not be filled, causing a problem of toner leakage.

### SUMMARY OF THE INVENTION

An object of the present invention is to provide a toner cartridge, as well as a recycling method therefor, capable of securely sealing a clearance generated between a housing and a lid, which are stacked on each other, and preventing toner leakage.

As a solution for achieving the above object, the present invention provides a toner cartridge which is set in an image forming apparatus to feed toner to the image forming apparatus, including:

a housing having a toner containing portion for containing toner therein; and

a lid for covering the toner containing portion of the housing, wherein

a stack portion where the housing and the lid are stacked on each other is sealed by a sealing member having first and second adhesive materials provided on both-side surfaces of a base material with the first adhesive material stuck on an outer peripheral surface of the stack portion and with a release paper stuck on the second adhesive material.

With this constitution, by the sealing member being stuck onto the outer peripheral surface of the stack portion where the housing and the lid are stacked on each other, the toner cartridge can be sealed.

As a solution for achieving the above object, the present invention provides a toner cartridge which is set in an image forming apparatus to feed toner to the image forming apparatus, comprising:

a housing having a toner containing portion for containing toner therein; and

a lid for covering the toner containing portion of the housing, wherein

a first adhesive material and at least one second sealing member are stuck on an outer peripheral surface of a stack portion where the housing and the lid are stacked on each other, and wherein the first sealing member has a first adhesive material and a second adhesive material provided on both-side surfaces of a base material, the first adhesive material being stuck on the outer peripheral surface of the stack portion and cut along the stack portion, while the second sealing member has a third adhesive material and a fourth adhesive material provided on both-side surfaces of the base material, the third adhesive material being stuck on the second adhesive material of the first sealing member, and the fourth adhesive material having a release paper stuck thereon.

With this constitution, in the toner cartridge in which the outer peripheral surface of the superposition portion, where the housing and the lid are superposed on each other, is sealed by sticking the first sealing member, the first sealing member is cut along the superposition portion, and the third sealing member of the second sealing member is stuck onto the second adhesive material of the first sealing member. Thus, the cutting surface of the first sealing member can be sealed.

Preferably, the toner cartridge further comprises a housing outer edge portion protruding outward from an upper face of the toner containing portion. In this case, the sealing member can be stuck with ease. Besides, the sealing member does not separate easily.

Preferably, the toner cartridge further comprises a lid outer edge portion which is put into contact with the housing outer edge portion to form a flat surface in combination with the outer peripheral surface of the housing outer edge portion when the lid is stacked on the housing. In this case, the sealing member can be stuck with ease. Besides, the sealing member does not separate easily.

Preferably, at least one of the housing outer edge portion and the lid outer edge portion has an L-shaped cross section. In this case, the outer peripheral surface of the housing outer edge portion or the lid outer edge portion becomes wider, so that the sealing member can be stuck with ease. Besides, the sealing member does not separate easily.

Preferably, a recess portion is provided along the stack portion in the outer peripheral surface of the stack portion. In this case, the cutter edge is inserted inside the recess portion in the sealing member cutting process, so that the sealing member can be cut with ease.

Preferably, the release paper of the second sealing member includes means for showing a number of re-sticking times of the sealing member. In this case, the number of recycling times of the toner cartridge can be known by the means for showing the number of re-sticking times of the sealing member. Thus, the life of component parts of the toner cartridge can be properly grasped.

Preferably, the means for showing a number of re-sticking times is a color of the release paper which is colored in correspondence to the number of re-sticking times. In this case, the number of re-sticking times can be shown by the color of the release paper which is colored.

Preferably, the release paper has its front and rear sides colored in different colors. In this case, since the release paper has its front and rear sides colored in different colors, two pieces of information can be shown by one sheet of release paper.

Preferably, the release paper has its front and rear sides colored each in a plurality of different colors. In this case, since the release paper has its front and rear sides colored each in a plurality of different colors, four or more pieces of information can be shown by one sheet of release paper.

As a solution for achieving the above object, the invention also provides a recycling method for a toner cartridge in which an opening surface of a housing is covered with a lid, a sealing member having adhesive materials provided on both-side surfaces of an adhesive material-use base material and having a release paper on a surface adhesive material is stuck on an outer peripheral surface of a stack portion where the housing and the lid are stacked on each other to seal the housing, the method comprising the steps of:

cutting along the stack surface the first sealing member stuck to the toner cartridge;

opening the toner cartridge, and after replacement of component parts or the like, covering the housing with the lid;

separating the release paper of the cut first sealing member; and

sticking an adhesive material of a second sealing member onto the adhesive material exposed by the separation.

With this method, the toner cartridge is opened by cutting the first sealing member stuck for sealing of the outer peripheral surface of the stack surface where the housing and the lid are stacked on each other with the opening surface of the housing covered with the lid, replacement of component parts or the like is done, the housing is covered with the lid, and the adhesive material of the second sealing member is stuck to the cutting portion of the cut first sealing member, by which the cutting portion of the first sealing member can be sealed. That is, toner leakage from the cutting portion of the first sealing member in the toner cartridge can reliably be prevented. Besides, recycling of the toner cartridge can be implemented with ease.

According to the present invention, since the sealing member is stuck to the outer peripheral surface of the stack portion where the housing and the lid are stacked on each other in the toner cartridge, toner leakage can be prevented. Also, after the cutting of the first sealing member stuck to the toner cartridge, only the release paper of the first sealing member is separated so as to make the adhesive material exposed, thus allowing a flat surface to be secured with ease. By the second sealing member being stuck onto the cut first sealing member, a clearance due to stack of the housing and the lid can reliably be sealed so that toner leakage can be prevented. Thus, recycling of the toner cartridge can be implemented with ease.

### BRIEF DESCRIPTION OF DRAWINGS

FIG. 1 is a schematic perspective view of a toner cartridge according to the present invention, as viewed from above;

FIG. 2 is a schematic perspective view of the toner cartridge with the housing and the lid separated from each other, as viewed from above;

FIG. 3(a) is a schematic longitudinal sectional view of the toner cartridge with the housing covered with the lid, and FIG. 3(b) is an enlarged partial sectional view showing a vicinity of a housing outer edge portion and a lid outer edge portion;

FIG. 4 is a schematic perspective view of the toner cartridge with no double-sided tape stuck thereon, as viewed from above;

FIG. 5(a) is a sectional view of a first double-sided tape to be used in this embodiment, and FIG. 5(b) is a sectional view of a second double-sided tape to be used in recycling of the toner cartridge;

FIG. 6 is a chart showing results of measuring separating force of various base materials;

FIGS. 7(a) to 7(e) are enlarged partial sectional views showing a recycling procedure;

FIG. 8 is an enlarged partial sectional view showing a vicinity of a housing outer edge portion and a lid outer edge portion in a toner cartridge according to another embodiment;

FIG. 9(a) shows a green second release paper, FIG. 9(b) shows a yellow second release paper, FIG. 9(c) shows a red second release paper and FIG. 9(d) shows a second release paper colored in different colors for front and rear, upper and lower portions; and

FIG. 10 is a view showing sticking start positions for the second double-sided tape.

### EXPLANATION OF NUMERALS

10 Toner cartridge
11 Housing
12 Lid
13 Screw
14 Stack portion
15 Double-sided tape (first sealing member)
16 Toner containing portion
17 Discharging part
18 Charging opening
19 Cap
20 Housing outer edge portion
20a Flange portion
21 Screw hole
22 Mixer
23 Mixer gear
24 Insertion hole
25 Screw
26 Flat plate portion
27 Lid outer edge portion
28 Screw insertion hole
31 First adhesive material
32 First adhesive material-use base material
33 Second adhesive material
34 First release paper
35 Double-sided tape (second sealing member)
36 Third adhesive material
37 Second adhesive material-use base material
38 Fourth adhesive material
39 Second release paper
39a Green second release paper
39b Yellow second release paper
39c Red second release paper
40 Recess portion
41 Cutting surface
42 First marking
43 Second marking
44 Third marking
45 First-time sticking start position

### DETAILED DESCRIPTION OF THE INVENTION

Hereinbelow, embodiments of the present invention will be described with reference to the accompanying drawings.

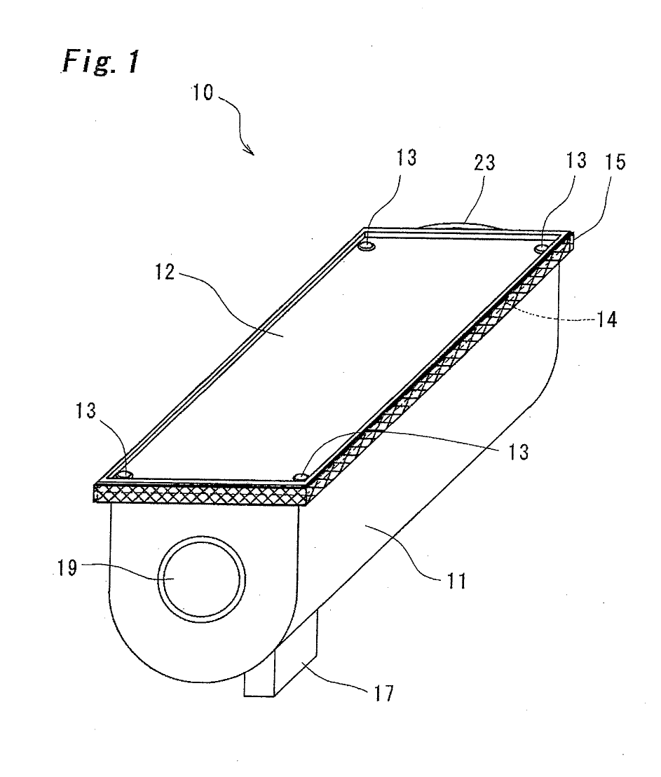

FIG. 1 is a schematic perspective view of a toner cartridge 10 according to the present invention, as viewed from above. The toner cartridge 10 is a container for containing fine, powdered toner to be used in such an image forming apparatus (not shown) such as copying machines and laser printers. The toner cartridge 10 is made up by covering a housing 11 with a lid 12, tightening the lid 12 to the housing 11 by screws 13, and sticking a double-sided tape (sealing material) to a stack portion (clearance) 14 of the housing 11 and the lid 12 to make a seal.

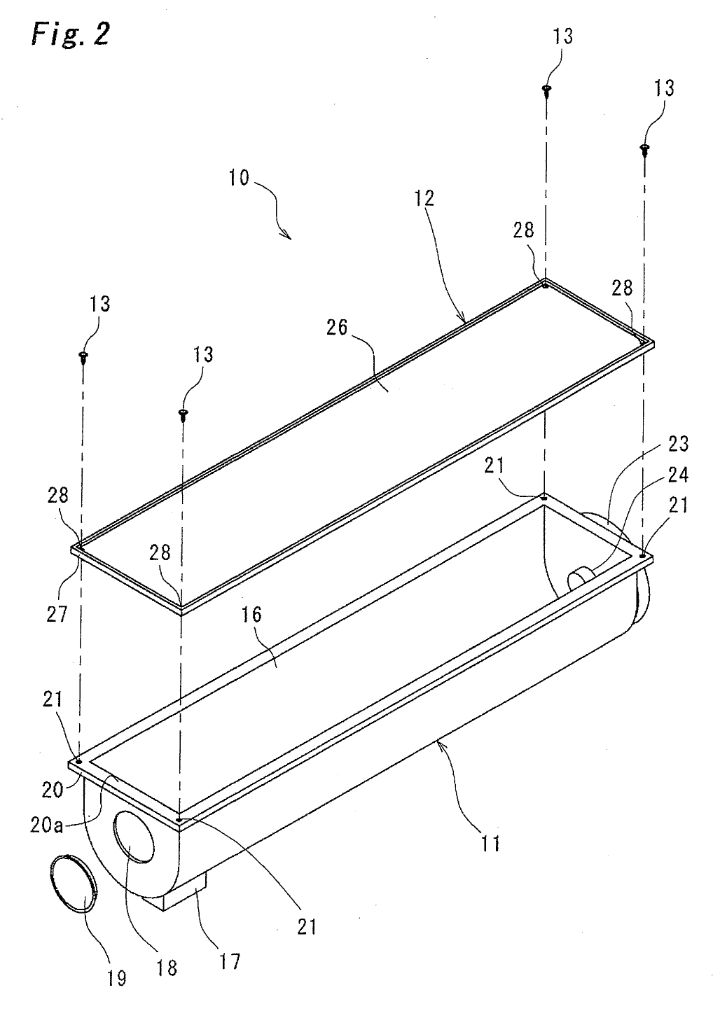

FIG. 2 is a schematic perspective view of the toner cartridge with the housing and the lid separated from each other, as viewed from above. The housing 11 and the lid 12 of this embodiment are made from resin, but may be from other materials.

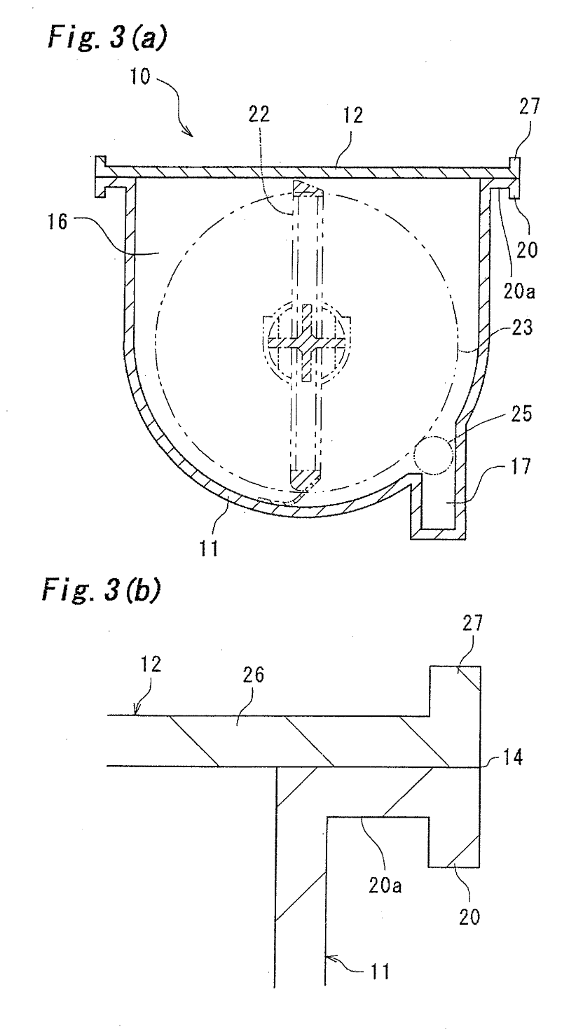

FIG. 3(a) is a schematic longitudinal sectional view of the toner cartridge 10 with the housing 11 covered with the lid 12. As shown in FIG. 3(a), the housing 11 is U-shaped in cross section, with its upper face opened, and a toner containing portion 16 is provided in its inside. On a front face side of the housing 11 is provided an discharging part 17 as a toner supply opening for discharging toner within the housing 11 to replenish toner to the image forming apparatus (not shown). The discharging part 17 protrudes downward from a bottom face of the housing 11, and a shutter for opening and closing an ejection opening (not shown) formed in the discharging part 17 is provided at a lower end portion of the discharging part 17. On the front side of the housing 11 is a charging opening 18 for charging toner to the toner cartridge 10. The charging opening 18 is sealed by a cap 19 except for the time of toner charging. A flange portion 20a extending outward of the housing 11 so as to be flush therewith and a housing outer edge portion 20 are provided on an outer periphery of an upper face of the toner containing portion 16. The housing outer edge portion 20 extends downward from an outer edge of the flange portion 20a so that the a cross-sectional shape formed by the housing outer edge portion 20 and the flange portion 20a becomes L-shaped. One screw hole 21 is provided at each of four corners of the flange portion 20a. An insertion hole 24 for inserting a rotating shaft of a mixer gear 23 for rotating a later-described mixer 22 is provided on the rear face side of the housing 11. A screw 25 as a conveying member for conveying the toner contained in the toner containing portion 16 to the discharging part 17 is provided at an inner bottom portion of the housing 11. A coupling member (not shown) as a driving member is provided at a forward end portion of a rear face-side end portion of the screw 25. Inside the housing 11 is provided a mixer 22 for stirring the toner in the toner containing portion 16. A mixer gear 23 is provided at a rear face-side end portion of the mixer 22 so as to be engaged with the coupling member (not shown), where rotating the screw 25 causes the mixer 22 to be rotated in leakage therewith.

The lid 12 is a rectangular-shaped thin plate composed of a flat plate portion 26 and a lid outer edge portion 27 provided at an outer edge of the flat plate portion 26. FIG. 3(b) is an enlarged partial sectional view showing a vicinity of the housing outer edge portion 20 of the housing 11 and the lid outer edge portion 27 of the lid 12 in the toner cartridge 10 with the housing 11 covered with the lid 12. The lid outer edge portion 27 of the lid 12 extends perpendicularly and upward from an outer edge of the flat plate portion 26 so that a cross-sectional shape formed by the lid outer edge portion 27 and the flat plate portion 26 becomes L-shaped. Screw insertion holes 28 are provided at four corners of the flat plate portion 26 of the lid 12.

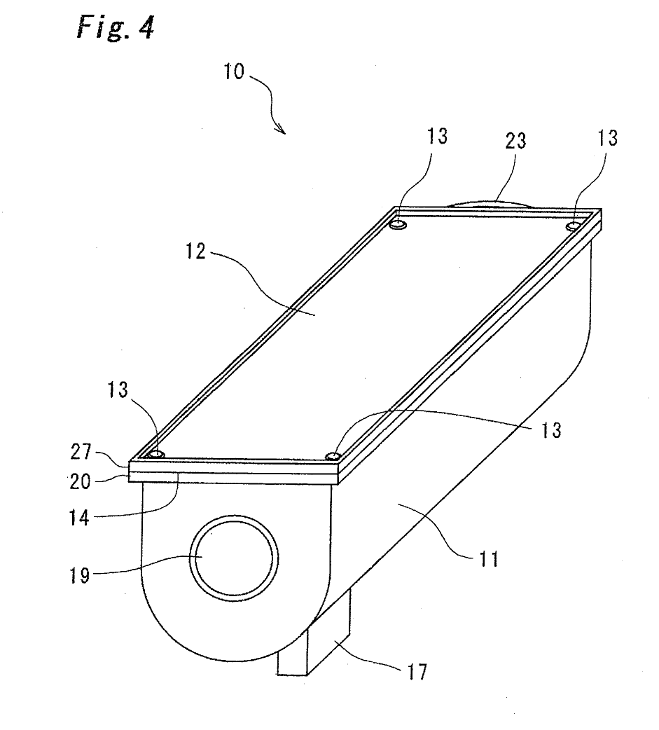

As shown in FIG. 4, the lid 12 shares a stack surface with the housing 11 relative to the opening surface of the housing 11, where the stack surface at which the bottom face of the lid outer edge portion 27 of the lid 12 and the upper face of the housing outer edge portion 20 of the housing 11 are stacked on each other. The lid 12 is set on the housing 11 so that an outer peripheral surface of the lid outer edge portion 27 of the lid 12 and an outer peripheral surface of the housing outer edge portion 20 of the housing 11 form a just congruous flat surface.

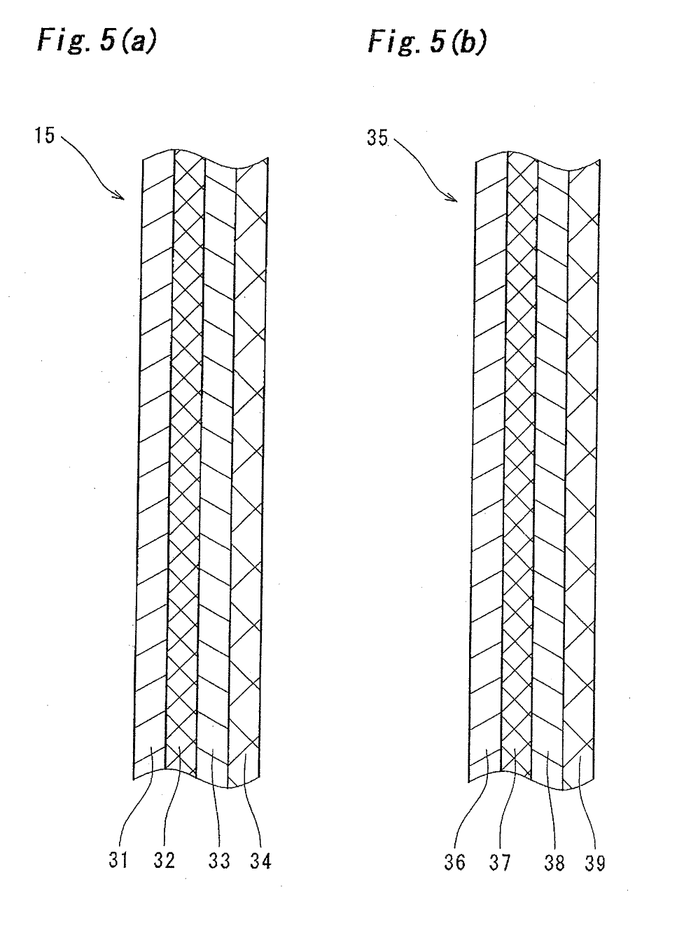

FIG. 5(a) is a sectional view of a first double-sided tape (first sealing member) 15 to be used in this embodiment. The first double-sided tape 15 is made up by lamination of four layers, i.e., a first adhesive material 31, a first adhesive material-use base material 32, a second adhesive material 33 and a first release paper 34. The first adhesive material 31 and the second adhesive material 33 are comparable in adhesive power to each other. The first release paper 34 protects a bonding surface of the second adhesive material 33 on its one side opposite to the side on which the first adhesive material-use base material 32 is provided.

FIG. 5(b) is a sectional view of a second double-sided tape (second sealing member) 35 to be used in recycling of the toner cartridge 10. Adhesive materials 36, 38 of the second double-sided tape (second sealing member) 35 are weaker in adhesive power than adhesive materials 31, 33 of the first double-sided tape 15. The second double-sided tape 35 is made up by lamination of four layers, i.e., a third adhesive material 36, a second adhesive material-use base material 37, a fourth adhesive material 38 and a second release paper 39. As the first double-sided tape 15 and the second double-sided tape 35, those which meet the following conditions are selected. Given an adhesive strength F1 between the second adhesive material 33 of the first double-sided tape 15 and the third adhesive material 36 of the second double-sided tape 35, an adhesive strength F2 between the first adhesive material 31 of the first double-sided tape 15 and the outer peripheral surfaces of the housing 11 and the lid 12, and an adhesive strength F3 between the second release paper 39 of the second double-sided tape 35 and the fourth adhesive material 38, then the first double-sided tape 15 and the second double-sided tape 35 satisfy a relationship that F2>F1>F3.

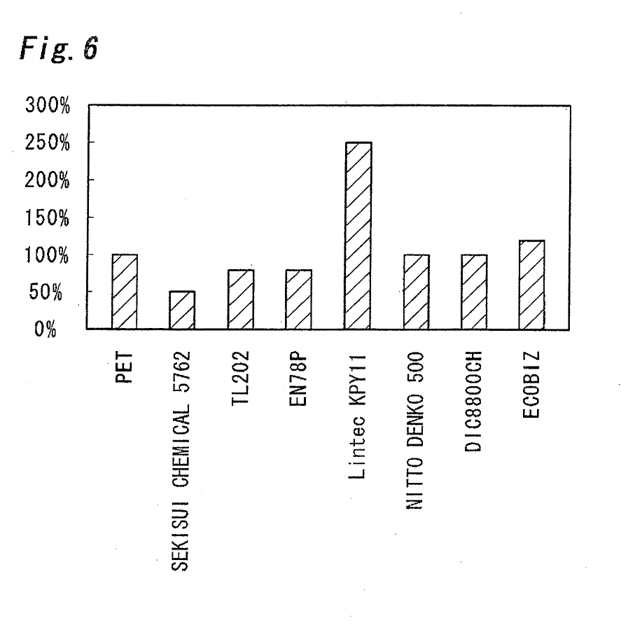

FIG. 6 shows results of measuring separating force of various base materials by the present inventor. In order to evaluate this results, individual base materials was stuck to an adhesive material tape and separating forces involved in separating those base materials, respectively, from the adhesive material tape was measured. The adhesive material tape was given by adopting 8800CH made by DIC Corporation, which is known as one for reduction of recycling cost by virtue of its satisfying strong adhesion and re-separation performance with an aim of efficiency improvement in assembling and disassembling of component units. The term, degree of separation, is herein defined as a quotient resulting from dividing a separating force of a base material by a separating force involved in separating a PET film from the adhesive material tape. A formula for determining the degree of separation (%) is as follows:

$$Degree Of Separation ( \% ) = \frac{Separating Force Of Base Material}{Separating Force Of PET Film} \times 100 \qquad [ Numerical Formula 1 ]$$

From results shown in FIG. 6, it can be understood that Lintec Corporation KPY11 showed larger separating force, as compared with the other base materials. That is, it can be understood that Lintec Corporation KPY11 showed larger adhesive power, as compared with the other base materials. According to these results, Lintec Corporation KPY11 was used as the first double-sided tape 15, and DIC Corporation 8800CH was used as the second double-sided tape 35.

Next, assembling of the toner cartridge 10 according to the invention will be described below.

As shown in FIG. 4, on the housing 11 in which individual components are set, the lid 12 is placed and tightened by the screws 13. Since at least one of the outer peripheral surfaces of the housing outer edge portion 20 and the lid outer edge portion 27 where the housing 11 and the lid 12 are stacked on each other has an L-shaped cross section, sticking of the first double-sided tape 15 is more easily achievable, and its separation is harder to do. The first double-sided tape 15 is desirably stuck in such a manner that its longitudinal center line coincides with the overall perimeter of a stack portion 14 of the housing 11 and the lid 12, though the first double-sided tape 15 may be stuck so that at least all the stack portion 14 is closed. Thereafter, with the cap 19 removed from the toner cartridge 10, toner is charged into the toner cartridge 10, and then the toner cartridge 10 is sealed by setting the cap 19. As a result, the clearance between the housing 11 and the lid 12 can be sealed, so that toner leakage can reliably be prevented.

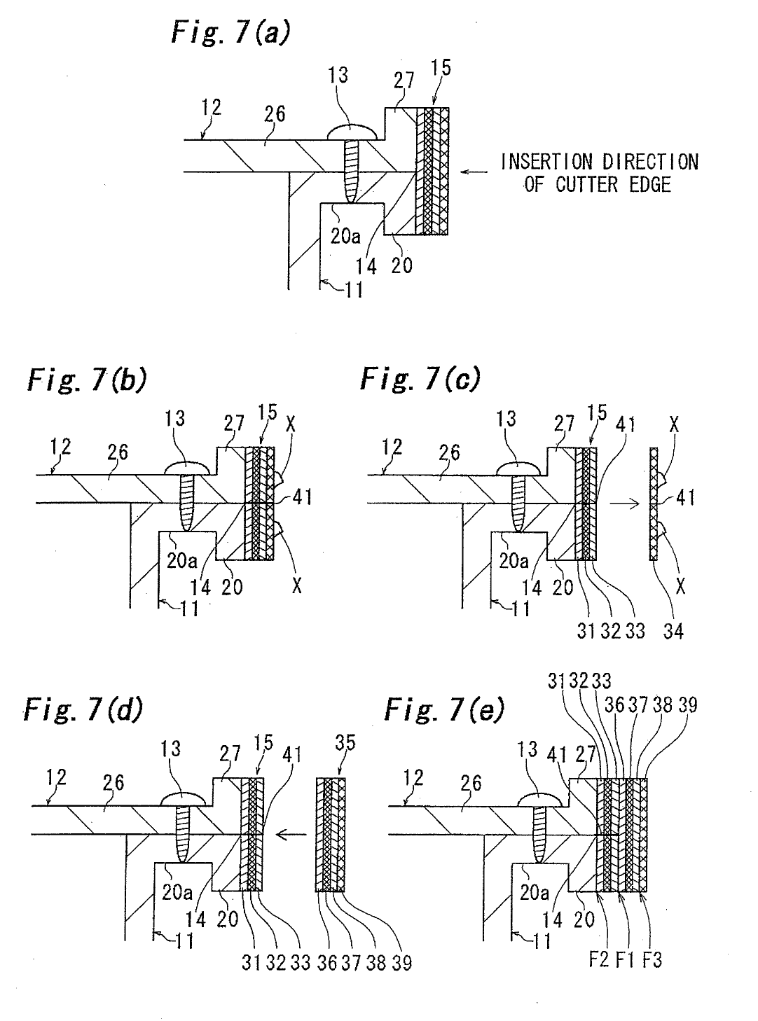

Next, a recycling method of the toner cartridge 10 is described below. As shown in FIG. 7(a), in replacing component parts or the like inside the housing 11 of the toner cartridge 10, first, a cutter edge is inserted generally in parallel with the stack surface from the first release paper 34 having stains X deposited so that the cutter edge reaches the stack portion 14 of the toner cartridge 10. Subsequently, the cutter edge is moved along the stack surface, by which the first double-sided tape 15 of the toner cartridge 10 is cut off. Thereafter, with the screws 13 loosened, the housing 11 and the lid 12 are separated from each other, allowing the toner cartridge 10 to be opened.

After replacement of component parts of the toner cartridge 10 or the like, the lid 12 is placed on the housing 11 and tightened by the screws 13. The first double-sided tape 15 remains the same as before cutting, except that the first double-sided tape 15 has been cut into two. Therefore, sealing its cutting surface 41 makes it possible to prevent toner leakage.

More specifically, in the toner cartridge 10 shown in FIG. 7(b), the first release paper 34 of the first double-sided tape 15 with stains deposited thereon is separated (FIG. 7(c)), so that the second adhesive material 33 having a flat surface is exposed. As shown in FIG. 7(d), the third adhesive material 36 of the second double-sided tape 35 is exposed, with the second release paper 39 positioned outside, and stuck onto the first double-sided tape 15 as shown in FIG. 7(e). By doing so, the first double-sided tape 15 of the toner cartridge 10 that has once been opened can be sealed by its cutting surface 41 again, so that toner leakage can reliably be prevented. With respect to the second double-sided tape 35, since the release paper 39 can be separated as in the case of the first double-sided tape 15, allowing a new second double-sided tape 35 to be stuck thereon, so that recycling of the toner cartridge 10 can be implemented repeatedly.

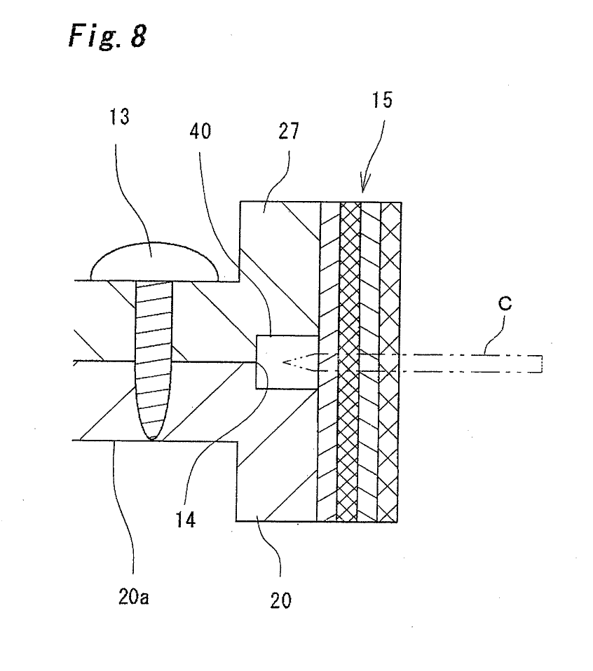

Without being limited to the embodiment, the invention may be modified in various ways. For example, as shown in FIG. 8, on the outer peripheral surfaces of the housing 11 and the lid 12, a recess portion 40 may be formed over both the housing 11 and the lid 12 including the stack portion 14 of the housing 11 and the lid 12. In this case, a forward end of a cutter C enters into the recess portion 40, facilitating the cutting of the sealing member. Further, forming the stack portion 14 of the housing 11 and the lid 12 generally linearly shaped allows the use of an automatic cutter device, so that efficiency improvement of the recycling work can be achieved.

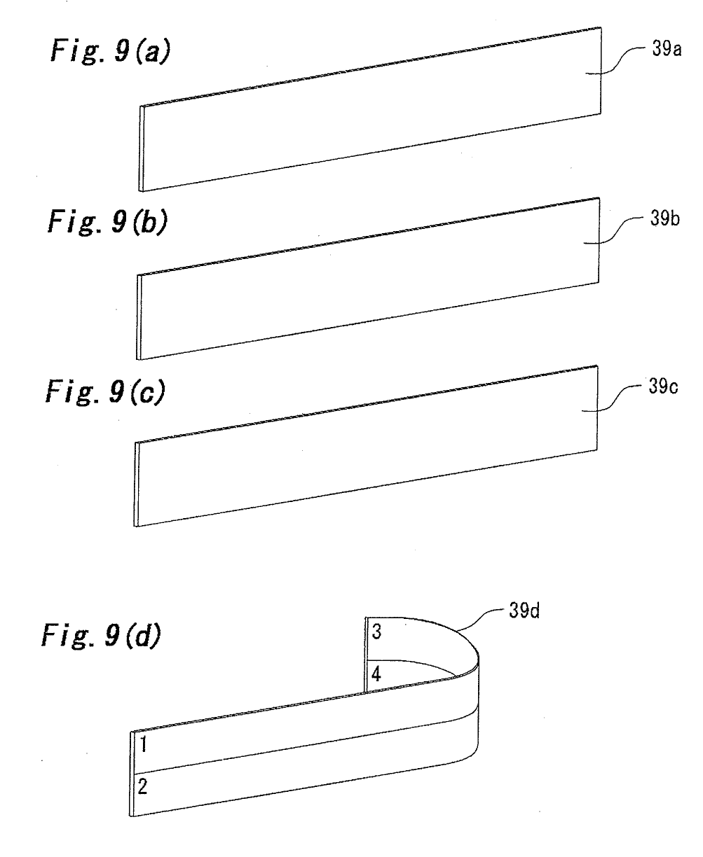

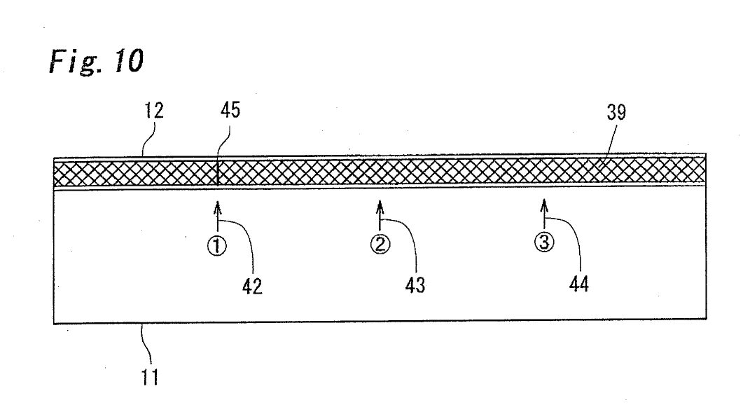

Also, the release paper 39 of the second double-sided tape 35 may be provided alternately by three release papers of three colors, e.g., a green second release paper 39a, a yellow second release paper 39b and a red second release paper 39c in this order, showing numbers of times of re-sticking, where a red release paper shows a life of recycling, which implies that no more recycling is impermissible. Still also, as shown in FIG. 9(d), the release paper 39 of the second double-sided tape 35 may be changed to a release paper 39d colored in different colors between front and rear and between upper and lower portions (e.g., front (upper 1: blue, lower 2: green), rear (upper 3: yellow, lower 4: red)), where the upper-side indication of the release paper 39d shows a number of recycling times so that the number of recycling times and the life can be discriminated. Further, as shown in FIG. 10, marks (e.g., a first marking 42, a second marking 43 and a third marking 44 in the housing 11) may be provided in the housing 11 or the lid 12, so that a number of recycling times can be discriminated by a sticking position of the release paper 39 (e.g., the first marking 42 is set at a first-time sticking start position 45, the second marking 43 is set at a second-time sticking start position, and the third marking 44 is set at a third-time sticking start position).

1. A Toner cartridge which is set in an image forming apparatus to feed toner to the image forming apparatus, comprising:
a housing having a toner containing portion for containing toner therein; and
a lid for covering the toner containing portion of the housing, wherein
a stack portion where the housing and the lid are stacked on each other is sealed by a sealing member having first and second adhesive materials provided on both-side surfaces of a base material with the first adhesive material stuck on an outer peripheral surface of the stack portion and with a release paper stuck on the second adhesive material.

2. The toner cartridge as claimed in claim 1, further comprising a housing outer edge portion protruding outward from an upper face of the toner containing portion.

3. The toner cartridge as claimed in claim 2, further comprising a lid outer edge portion which is put into contact with the housing outer edge portion to form a flat surface in combination with the outer peripheral surface of the housing outer edge portion when the lid is stacked on the housing.

4. The toner cartridge as claimed in claim 3, wherein at least one of the housing outer edge portion and the lid outer edge portion has an L-shaped cross section.

5. The toner cartridge as claimed in claim 1, wherein a recess portion is provided along the stack portion in the outer peripheral surface of the stack portion.

6. A toner cartridge which is set in an image forming apparatus to feed toner to the image forming apparatus, comprising:
a housing having a toner containing portion for containing toner therein; and
a lid for covering the toner containing portion of the housing, wherein
a first adhesive material and at least one second sealing member are stuck on an outer peripheral surface of a stack portion where the housing and the lid are stacked on each other, and wherein the first sealing member has a first adhesive material and a second adhesive material provided on both-side surfaces of a base material, the first adhesive material being stuck on the outer peripheral surface of the stack portion and cut along the stack portion, while the second sealing member has a third adhesive material and a fourth adhesive material provided on both-side surfaces of the base material, the third adhesive material being stuck on the second adhesive material of the first sealing member, and the fourth adhesive material having a release paper stuck thereon.

7. The toner cartridge as claimed in claim 6, further comprising a housing outer edge portion protruding outward from an upper face of the toner containing portion.

8. The toner cartridge as claimed in claim 7, further comprising a lid outer edge portion which is put into contact with the housing outer edge portion to form a flat surface in combination with the outer peripheral surface of the housing outer edge portion when the lid is stacked on the housing.

9. The toner cartridge as claimed in claim 8, wherein at least one of the housing outer edge portion and the lid outer edge portion has an L-shaped cross section.

10. The toner cartridge as claimed in claim 6, wherein a recess portion is provided along the stack portion in the outer peripheral surface of the stack portion.

11. The toner cartridge as claimed in claim 6, wherein the release paper of the second sealing member includes means for showing a number of re-sticking times of the sealing member.

12. The toner cartridge as claimed in claim 11, wherein the means for showing a number of re-sticking times is a color of the release paper which is colored in correspondence to the number of re-sticking times.

13. The toner cartridge as claimed in claim 12, wherein the release paper has its front and rear sides colored in different colors.

14. The toner cartridge as claimed in claim 12, wherein the release paper has its front and rear sides colored each in a plurality of different colors.

15. A recycling method for a toner cartridge in which an opening surface of a housing is covered with a lid, a sealing member having adhesive materials provided on both-side surfaces of an adhesive material-use base material and having a release paper on a surface adhesive material is stuck on an outer peripheral surface of a stack portion where the housing and the lid are stacked on each other to seal the housing, comprising the steps of:
cutting along the stack surface the first sealing member stuck to the toner cartridge;
opening the toner cartridge, and after replacement of component parts or the like, covering the housing with the lid;
separating the release paper of the cut first sealing member; and
sticking an adhesive material of a second sealing member onto the adhesive material exposed by the separation.
